(19) United States
(12) Patent Application Publication
(10) Pub. No.: US 2024/0151443 A1
(43) Pub. Date: May 9, 2024

(54) REFRIGERATION CYCLE APPARATUS, CONTROL METHOD FOR REFRIGERATION CYCLE APPARATUS, AND NON-TRANSITORY COMPUTER-READABLE RECORDING MEDIUM

(71) Applicant: Mitsubishi Electric Corporation, Tokyo (JP)

(72) Inventors: Takahiro NARUI, Tokyo (JP); Mizuo SAKAI, Tokyo (JP); Tetsuya YAMASHITA, Tokyo (JP); Kazuya WATANABE, Tokyo (JP); Satoshi AKITOMO, Tokyo (JP)

(21) Appl. No.: 18/550,760

(22) PCT Filed: Sep. 3, 2021
(86) PCT No.: PCT/JP2021/032382

§ 371 Date: Sep. 15, 2023

(51) Int. Cl. F25B 41/31; G05B 15/02

(52) U.S. Cl. CPC F25B 41/31; G05B 15/02

(57) ABSTRACT

A refrigeration cycle apparatus includes a refrigerant circuit in which a compressor, a heat source side heat exchanger, an expansion valve, and a user side heat exchanger are connected by a refrigerant pipe. Further, the refrigeration cycle apparatus includes a detector configured to detect a discharge temperature of the compressor, and a heat transfer pipe temperature and an outlet pipe temperature of the heat exchanger functioning as a condenser; and a controller capable of performing a supercooling degree control and a discharge temperature control or a discharge superheating degree control, based on a result of the detection by the detector. The controller is configured to control an opening degree of the expansion valve based on any of the supercooling degree control and the discharge temperature control or the discharge superheating degree control, according to operating characteristics of the refrigeration cycle apparatus.

### CROSS-REFERENCE TO RELATED APPLICATION

This application is a U.S. National Stage Application of International Application No. PCT/JP2021/032382, filed Sep. 3, 2021, the contents of which are incorporated herein by reference.

### TECHNICAL FIELD

The present disclosure relates to a refrigeration cycle apparatus, a control method for the refrigeration cycle apparatus, and a non-transitory computer-readable recording medium.

### BACKGROUND

Among refrigeration cycle apparatuses in which a compressor, a heat source side heat exchanger, an electronic expansion valve, and a user side heat exchanger are connected by refrigerant pipes, a common refrigeration cycle apparatus is one having a supercooling degree control function of controlling an opening degree of the expansion valve so that a value of a supercooling degree of a heat exchanger functioning as a condenser is within a predetermined range (see, for example, Patent Document 1).

### PATENT DOCUMENT

[Patent Document 1] Japanese Patent Application Publication No. 2010-96474

Conventional refrigeration cycle apparatuses such as described in Patent Document 1 are likely to stop the operation to prevent, for example, an abnormality in discharge temperature of the heat exchanger functioning as a condenser. The supercooling degree is calculated from values of a heat transfer pipe temperature and an outlet pipe temperature to control the opening degree of the expansion valve. Depending on installation environments and operating conditions of the refrigeration cycle apparatus, however, it may not be possible to secure a sufficient supercooling degree for the control. In this case, the refrigeration cycle apparatus continues to narrow the opening degree of the expansion valve in order to secure the supercooling degree. For this reason, a discharge temperature and a discharge superheating degree increase excessively, so that there is a risk that the operation will be stopped to prevent the abnormality in discharge temperature.

### SUMMARY

The present disclosure has been made in view of the above-described circumstances, and one of the objects thereof is to provide a highly reliable refrigeration cycle apparatus that does not stop the operation due to an abnormality in discharge temperature even in an operating state where it is difficult to secure the supercooling degree.

A refrigeration cycle apparatus according to the present disclosure is a refrigeration cycle apparatus including a refrigerant circuit in which a compressor, a heat source side heat exchanger, an expansion valve, and a user side heat exchanger are connected by a refrigerant pipe. The refrigeration cycle apparatus includes: a detector configured to detect a discharge temperature of the compressor, and a heat transfer pipe temperature and an outlet pipe temperature of at least one heat exchanger of the heat source side heat exchanger and the user side heat exchanger, the at least one heat exchanger functioning as a condenser; and a controller capable of performing a supercooling degree control and a discharge temperature control or a discharge superheating degree control, based on a result of the detection by the detector. The controller is configured to, when the refrigeration cycle apparatus starts operating, control an opening degree of the expansion valve based on the supercooling degree control, and when determining based on operating characteristics of the refrigeration cycle apparatus that the supercooling degree control cannot be continued, switch the control of the opening degree of the expansion valve from the supercooling degree control to the discharge temperature control or the discharge superheating degree control.

A control method according to the present disclosure is for a refrigeration cycle apparatus including a refrigerant circuit in which a compressor, a heat source side heat exchanger, an expansion valve, and a user side heat exchanger are connected by a refrigerant pipe. The control method includes: detecting a discharge temperature of the compressor, and a heat transfer pipe temperature and an outlet pipe temperature of at least one heat exchanger of the heat source side heat exchanger and the user side heat exchanger, the at least one heat exchanger functioning as a condenser; performing a supercooling degree control and a discharge temperature control or a discharge superheating degree control, based on a result of the detection; when the refrigeration cycle apparatus starts operating, controlling an opening degree of the expansion valve based on the supercooling degree control; and when determining based on operating characteristics of the refrigeration cycle apparatus that the supercooling degree control cannot be continued, switching the control of the opening degree of the expansion valve from the supercooling degree control to the discharge temperature control or the discharge superheating degree control.

A non-transitory computer-readable recording medium according to the present disclosure stores instructions causing a computer of a refrigeration cycle apparatus comprising a refrigerant circuit in which a compressor, a heat source side heat exchanger, an expansion valve, and a user side heat exchanger are connected by a refrigerant pipe to: detect a discharge temperature of the compressor, and a heat transfer pipe temperature and an outlet pipe temperature of at least one heat exchanger of the heat source side heat exchanger and the user side heat exchanger, the at least one heat exchanger functioning as a condenser; perform a supercooling degree control and a discharge temperature control or a discharge superheating degree control, based on a result of the detection; when the refrigeration cycle apparatus starts operating, control an opening degree of the expansion valve based on the supercooling degree control; and when determining based on operating characteristics of the refrigeration cycle apparatus that the supercooling degree control cannot be continued, switch the control of the opening degree of the expansion valve from the supercooling degree control to the discharge temperature control or the discharge superheating degree control.

According to the present disclosure, it is possible to provide a highly reliable refrigeration cycle apparatus that does not stop the operation due to an abnormality in discharge temperature even in an operating state where it is difficult to secure the supercooling degree.

### BRIEF DESCRIPTION OF THE DRAWINGS

FIG. 1 is a block diagram showing a configuration example of a refrigeration cycle apparatus according to a first embodiment.

FIG. 2 is a p-h diagram during a cooling operation of the refrigeration cycle apparatus according to the first embodiment.

FIG. 3 is a p-h diagram during an SC control performed by the refrigeration cycle apparatus according to the first embodiment.

FIG. 4 is a p-h diagram during a Td control performed by the refrigeration cycle apparatus according to the first embodiment.

FIG. 5 is a p-h diagram during an SHd control performed by the refrigeration cycle apparatus according to the first embodiment.

FIG. 6 is a flowchart showing an example of switching processing of switching between the SC control and the Td control or the SHd control according to the first embodiment.

FIG. 7 is a flowchart showing an example of switching processing of switching between the SC control and the Td control or the SHd control according to a second embodiment.

FIG. 8 is a flowchart showing an example of switching processing of switching between the SC control and the Td control or the SHd control according to a third embodiment.

FIG. 9 is a flowchart showing an example of switching processing of switching between the SC control and the Td control or the SHd control according to a fourth embodiment.

FIG. 10 is a flowchart showing an example of switching processing of switching between the SC control and the Td control or the SHd control according to a fifth embodiment.

### DETAILED DESCRIPTION

Embodiments will be described below with reference to the drawings.

### First Embodiment

First, a first embodiment will be described.

### [Configuration of Refrigeration Cycle Apparatus]

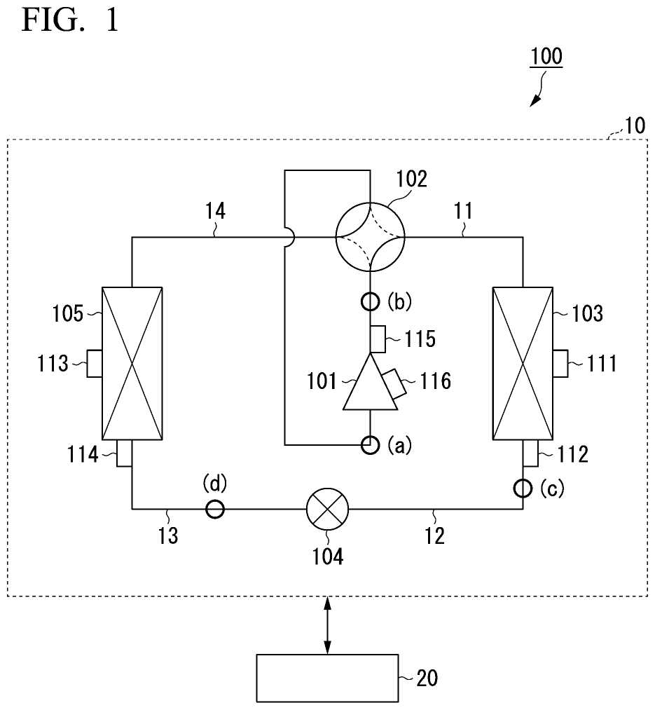

FIG. 1 is a block diagram showing a configuration example of a refrigeration cycle apparatus 100 according to the present embodiment. The illustrated refrigeration cycle apparatus 100 includes a refrigerant circuit 10 and a controller 20 that controls the refrigerant circuit 10. The refrigerant circuit 10 includes a compressor 101, a refrigerant switcher 102 that switches a flow direction of a refrigerant, a heat source side heat exchanger 103, an expansion valve 104 (electronic expansion valve), a user side heat exchanger 105, and pipes 11, 12, 13, and 14 as refrigerant pipes that connect those respective elements in sequence.

The pipe 11 is a refrigerant pipe that connects between the compressor 101 and the heat source side heat exchanger 103. The pipe 12 is a refrigerant pipe that connects between the heat source side heat exchanger 103 and the expansion valve 104. The pipe 13 is a refrigerant pipe that connects between the expansion valve 104 and the user side heat exchanger 105. The pipe 14 is a refrigerant pipe that connects between the user side heat exchanger 105 and the compressor 101.

The refrigerant switcher 102 includes a four-way valve that switches the flow direction of the refrigerant, and is connected between the pipe 11 downstream of the compressor 101 and the pipe 14 upstream of the compressor 101. During a cooling operation, the connection of the refrigerant switcher 102 is made in a direction indicated by a solid line shown in FIG. 1. During a heating operation, the connection of the refrigerant switcher 102 is made in a direction indicated by a broken line shown in FIG. 1.

The heat source side heat exchanger 103 functions as a heat source device or heat source side unit that generates heat to be supplied to the user side heat exchanger 105. The user side heat exchanger 105 functions as a load side unit that uses the heat supplied from the heat source side heat exchanger 103.

A heat transfer pipe and an outlet pipe (outlet side pipe) of each of the heat source side heat exchanger 103 and the user side heat exchanger 105, a discharge pipe downstream of the compressor 101, and a container surface of the compressor 101 are each provided with a temperature detector as an example of a detector for detecting a temperature of the refrigerant of each element.

In FIG. 1, a temperature detector 111 is a temperature detector for detecting a temperature of a heat transfer pipe of the heat source side heat exchanger 103. A temperature detector 112 is a temperature detector for detecting a temperature of the outlet pipe (outlet side pipe temperature) of the heat source side heat exchanger 103. A temperature detector 113 is a temperature detector for detecting a temperature of a heat transfer pipe of the user side heat exchanger 105. A temperature detector 114 is a temperature detector for detecting a temperature of the outlet pipe of the user side heat exchanger 105. A temperature detector 115 is a temperature detector for detecting a temperature of the discharge pipe downstream of the compressor 101. A temperature detector 116 is a temperature detector for detecting a temperature of the container surface of the compressor 101.

The detector for detecting a temperature of the refrigerant uses a temperature detector such as a temperature sensor. Alternatively, for a temperature of the heat transfer pipe of a heat exchanger functioning as a condenser (hereinafter referred to as “condensation temperature”), a temperature of the refrigerant may be indirectly detected using a saturation temperature of the refrigerant obtained from a pressure of the refrigerant detected using a pressure detector, in lieu of the temperature detector.

The controller 20 controls a flow of the refrigerant in the refrigerant circuit 10 and each element of the refrigerant circuit 10 according to an operating state such as the cooling operation or the heating operation. For example, the controller 20 controls an opening degree of the expansion valve 104 based on a result of the above-described detection by the temperature detector and the operating characteristics.

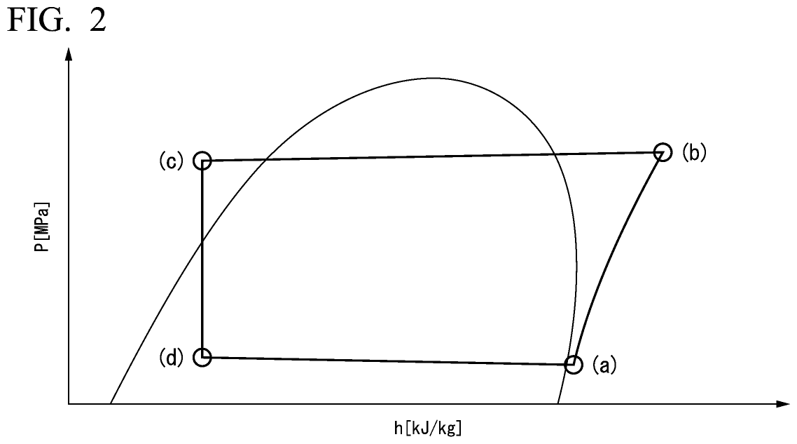

FIG. 2 is an example of a p-h diagram during the cooling operation of the refrigeration cycle apparatus 100 according to the present embodiment. In this figure, a vertical axis indicates pressure p (MPa), and a horizontal axis indicates specific enthalpy h (kJ/kg). Note that points (a) to (d) in FIG. 2 indicate states of the refrigerant at the portions denoted by the same symbols in FIG. 1.

When the compressor 101 starts operating, a low-temperature low-pressure gas refrigerant is compressed by the compressor 101 and discharged as a high-temperature high-pressure gas refrigerant. In this refrigerant compression process by the compressor 101, as indicated by a line from the point (a) to the point (b), the refrigerant is compressed so as to be heated by an adiabatic efficiency of the compressor 101 as compared with a case of adiabatic compression along an isentropic line.

The high-temperature high-pressure gas refrigerant discharged from the compressor 101 passes through the refrigerant switcher 102 and flows into the heat source side heat exchanger 103. The refrigerant that has flowed into the heat source side heat exchanger 103 is cooled while heating an outdoor air, and becomes a medium-temperature high-pressure liquid refrigerant. Considering a pressure loss in the heat exchanger, the change of the refrigerant in the heat source side heat exchanger 103 is indicated by a line from the point (b) to the point (c) shown in FIG. 2, which is inclined slightly downward to the left from the horizontal.

The medium-temperature high-pressure liquid refrigerant that has flowed out of the heat source side heat exchanger 103 is expanded and decompressed through the expansion valve 104, and becomes a low-temperature low-pressure gas-liquid two-phase flow state. The change of the refrigerant at the time of passing through the expansion valve 104 is made under a constant enthalpy condition. The change of the refrigerant at this time is indicated by a vertical line from the point (c) to the point (d) shown in FIG. 2.

The refrigerant in the low-temperature low-pressure gas-liquid two-phase flow state, which has flowed out of the expansion valve 104, flows into the user side heat exchanger 105. The refrigerant that has flowed into the user side heat exchanger 105 is heated while cooling an indoor air, and becomes a low-temperature low-pressure gas refrigerant. Considering a pressure loss in the heat exchanger, the change of the refrigerant in the user side heat exchanger 105 is indicated by a line from the point (d) to the point (a) in FIG. 2, which is inclined slightly downward to the right from the horizontal.

The low-temperature low-pressure gas refrigerant that has flowed out of the user side heat exchanger 105 passes through the refrigerant switcher 102, flows into the compressor 101, and is compressed. In the case of the heating operation, the connection of the refrigerant switcher 102 is switched under the control of the controller 20, and the evaporator and the condenser are reversed, but the behavior of the p-h diagram does not change.

Conventionally, it has been common to perform a supercooling degree control (hereinafter referred to as “SC control”) which is the control performed using a supercooling degree (hereinafter referred to as “SC”) that is a difference between a condensation temperature of the heat exchanger functioning as a condenser and an outlet pipe temperature (hereinafter referred to as “condenser outlet temperature.”) In the refrigeration cycle apparatus 100 as well, the controller 20 uses the SC control as a normal control. [Description of Supercooling Degree Control]

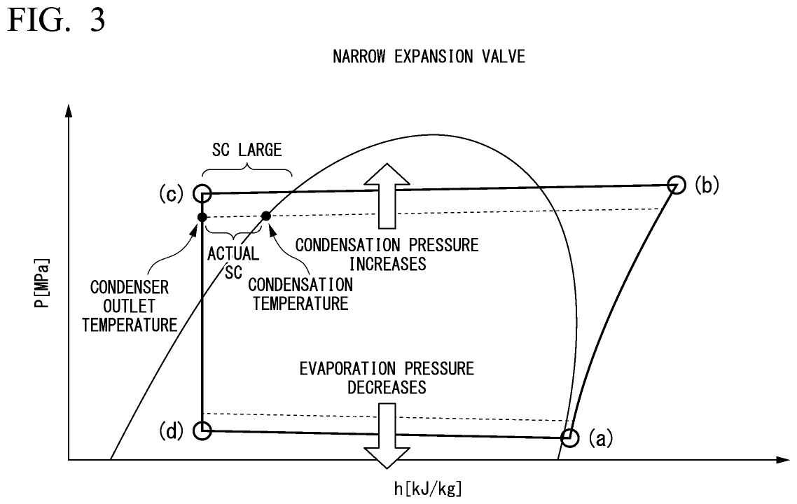

FIG. 3 is an example of a p-h diagram during the SC control performed by the refrigeration cycle apparatus 100 according to the present embodiment. In the SC control, the controller 20 adjusts the opening degree of the expansion valve 104 so that a calculated value of an SC which is a difference between a measured value of the condensation temperature and a measured value of the condenser outlet temperature (hereinafter referred to as “actual SC”) becomes within a predetermined SC range (for example, 2 to 6 degrees). The controller 20 narrows the expansion valve 104 when the actual SC is lower than the predetermined SC range during the SC control. By narrowing the expansion valve 104, the controller 20 decreases an amount of the refrigerant circulated, increases a condensation pressure, and decreases an evaporation pressure, thereby increasing the value of the SC so as to fall within the predetermined SC range.

Note that, contrary to the example shown in FIG. 3, the controller 20 opens the expansion valve 104 when the actual SC exceeds the predetermined SC range during the SC control. By opening the expansion valve 104, the controller 20 increases the amount of the refrigerant circulated, decreases the condensation pressure, and increases the evaporation pressure, thereby decreasing the SC value so as to fall within the predetermined SC range.

Here, the purpose of the SC control is to improve performance. The necessary performance of the user side heat exchanger 105 is achieved by controlling the SC within the predetermined SC range and ensuring a condenser enthalpy difference which is a difference between an inlet enthalpy of the heat exchanger functioning as a condenser (hereinafter referred to as “condenser inlet enthalpy”) and an outlet enthalpy of the heat exchanger (hereinafter referred to as “condenser outlet enthalpy”).

### [Description of Discharge Temperature Control]

Further, in controlling the refrigeration cycle apparatus 100, it is also possible for the controller 20 to perform a discharge temperature control (hereinafter referred to as “Td control”) in which the control is performed using a discharge temperature (hereinafter referred to as “Td”) while regarding a discharge pipe temperature downstream of the compressor 101 or the surface temperature of the container of the compressor 101 as a representative temperature of the discharge temperature.

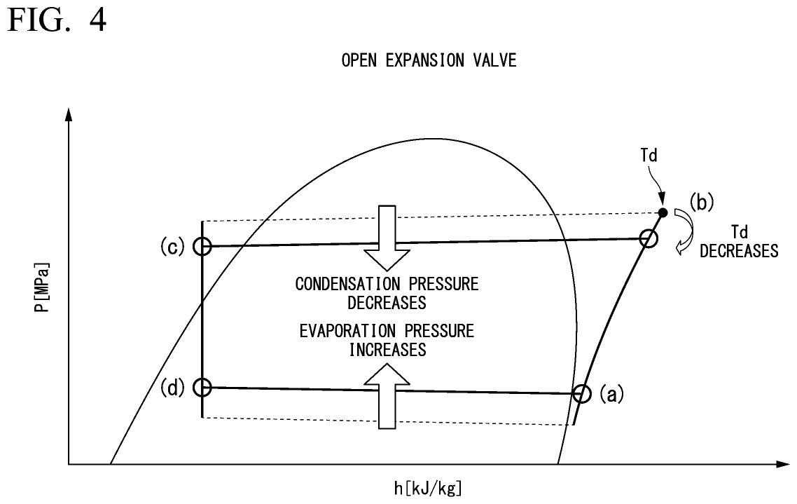

FIG. 4 is an example of a p-h diagram during the Td control performed by the refrigeration cycle apparatus 100 according to the present embodiment. In the Td control, the controller 20 adjusts the opening degree of the expansion valve 104 so that a detected measured value of a Td (hereinafter referred to as “actual Td”) falls within a predetermined Td range (for example, 60 to 100 degrees). The controller 20 opens the expansion valve 104 when the actual Td exceeds the predetermined Td range during the Td control. By opening the expansion valve 104, the controller 20 increases the amount of the refrigerant circulated, decreases the condensation pressure, and increases the evaporation pressure, thereby decreasing the value of the Td so as to fall within the predetermined Td range.

Note that, contrary to the example shown in FIG. 4, the controller 20 narrows the expansion valve 104 when the actual Td is lower than the predetermined Td range during the Td control. By narrowing the expansion valve 104, the controller 20 decreases the amount of the refrigerant circulated, increases the condensation pressure, and decreases the evaporation pressure, thereby increasing the value of the Td so as to fall within the predetermined Td range.

### [Description of Discharge Superheating Degree Control]

Note that it is also possible for the controller 20 to perform, in lieu of the Td control, a discharge superheating degree control (hereinafter referred to as “SHd control”) in which the control is performed using a discharge superheating degree (hereinafter referred to as “SHd”) which is a difference between the Td and the condensation temperature.

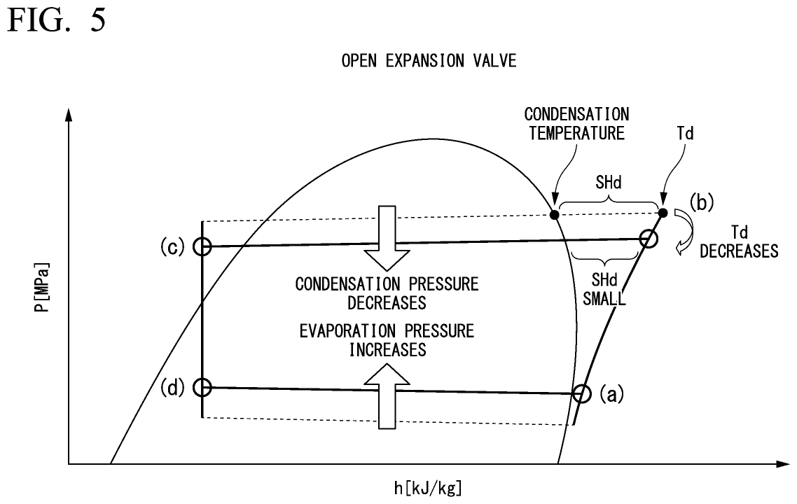

FIG. 5 is an example of a p-h diagram during the SHd control performed by the refrigeration cycle apparatus 100 according to the present embodiment. In the SHd control, the controller 20 adjusts the opening degree of the expansion valve 104 so that a calculated value of an SHd (hereinafter referred to as “actual SHd”) which is a difference between the actual Td and the measured value of the condensation temperature falls within a predetermined SHd range (for example, 20 to 30 degrees). The controller 20 opens the expansion valve 104 when the actual SHd exceeds the predetermined SHd range during the SHd control. By opening the expansion valve 104, the controller 20 increases the amount of the refrigerant circulated, decreases the condensation pressure, and increases the evaporation pressure, thereby decreasing the SHd value so as to fall within the predetermined SHd range.

Note that, contrary to the example shown in FIG. 5, the controller 20 narrows the expansion valve 104 when the actual SHd is lower than the predetermined SHd range during the SHd control. By narrowing the expansion valve 104, the controller 20 decreases the amount of the refrigerant circulated, increases the condensation pressure, and decreases the evaporation pressure, thereby increasing the value of the SHd so as to fall within the predetermined range.

Here, the purpose of the Td control or the SHd control is to ensure reliability of the operation. During the operation of the compressor 101, the temperature of the compressed refrigerant becomes high, and the container of the compressor 101 in which the structure of the compressor 101, the motor, and the like are built is heated. The controller 20 can prevent motor windings of the compressor 101 from being demagnetized by controlling the Td within the predetermined Td range. Further, during a low-load operation, it is conceivable that wet gas may be sucked into the compressor 101 and a liquid back operation may occur. By controlling the Td or the SHd within the predetermined range, the controller 20 can control the suction state of the compressor 101 and ensure the reliability of the compressor 101.

In the refrigeration cycle apparatus 100 according to the present embodiment, the controller 20 can switch between the SC control and the Td control or the SHd control according to the operating characteristics of the refrigeration cycle apparatus 100. For example, the controller 20 controls the opening degree of the expansion valve 140 based on any of the SC control and the Td control or the SHd control, based on a result of the detection by the detector and the operating characteristics of the refrigeration cycle apparatus 100.

### [Description of Operation of Control Switching Processing]

Next, an operation of switching processing in which the controller 20 of the refrigeration cycle apparatus 100 switches between the SC control and the Td control or the SHd control based on the operating characteristics will be described.

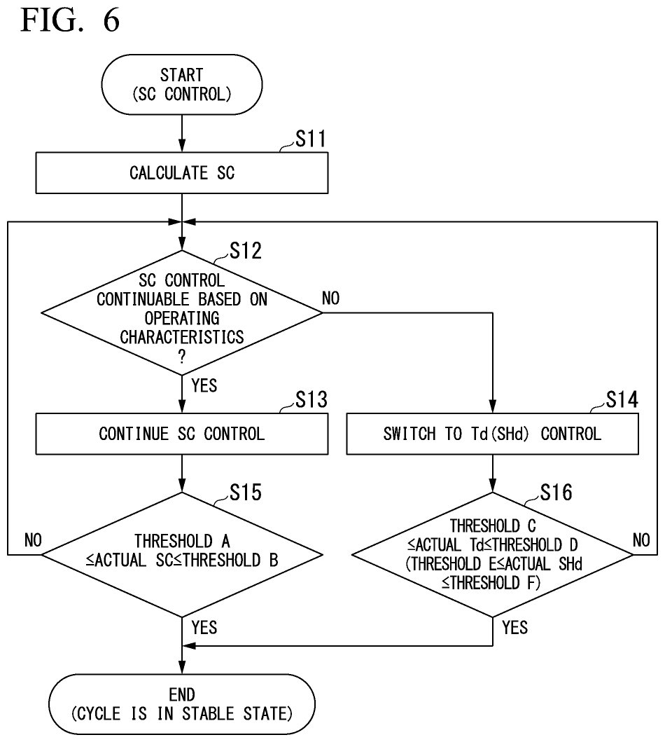

FIG. 6 is a flowchart showing an example of switching processing of switching between the SC control and the Td control or the SHd control according to the operating characteristics in the refrigeration cycle apparatus 100 according to the present embodiment. Note that at the start of the operation of the refrigeration cycle apparatus 100, the controller 20 performs the SC control in order to ensure the necessary capacity, as in the conventional control.

The controller 20 calculates an SC during the operation (step S11). For example, the controller 20 calculates an SC during the operation based on the condensation temperature detected by the temperature detector 111 and the condenser outlet temperature detected by the temperature detector 112, and then proceeds to step S12.

The controller 20 determines whether or not the SC control can be continued based on the operating characteristics of the refrigeration cycle apparatus 100 (step S12). Examples of the operating characteristics of the refrigeration cycle apparatus 100 include a magnitude of the air conditioning load during the operation, a value of the SC, an opening degree of the expansion valve 104, and the like. Methods of determining these specific operating characteristics will be described later in second to fourth embodiments. When determining in step S12 that the SC control can be continued (YES), the controller 20 continues the SC control (step S13).

On the other hand, when determining in step S12 that the SC control cannot be continued (NO), the controller 20 switches the SC control to the Td control or the SHd control (step S14). For example, the controller 20 detects a Td (discharge temperature) using the temperature detector 115 or the temperature detector 116, and performs the Td control based on the detected Td. Alternatively, the controller 20 may calculate an SHd (discharge superheating degree) which is a difference between the detected Td and the condensation temperature, and perform the SHd control based on the calculated SHd.

When the SC control is continued in step S13, the controller 20 determines whether or not the actual SC is within the predetermined SC range (for example, 2 to 6 degrees) (step S15). For example, the controller 20 determines in step S15 whether or not the actual SC is equal to or higher than a threshold A (for example, 2 degrees) and equal to or lower than a threshold B (for example, 6 degrees). When determining that the actual SC is not within the predetermined SC range (NO), the controller 20 returns to step S12 and makes a determination again based on the operating characteristics.

On the other hand, when determining in step S15 that the actual SC is within the predetermined SC range (YES), the controller 20 determines that the refrigeration cycle is in a stable state, and ends the control switching processing. Note that the controller 20 may determine that the refrigerating cycle is in the stable state, after determining that the operating SC is within the predetermined SC range for a certain period of time.

When the SC control is switched to the Td control in step S14, the controller 20 determines whether or not the actual Td is within the predetermined Td range (for example, 60 to 100 degrees) (step S16). For example, the controller 20 determines whether or not the actual Td is equal to or higher than a threshold C (for example, 60 degrees) and equal to or lower than a threshold D (for example, 100 degrees). When determining in step S16 that the actual Td is not within the predetermined Td range (NO), the controller 20 returns to step S12 and makes a determination again based on the operating characteristics.

On the other hand, when determining in step S16 that the actual Td is within the predetermined Td range (YES), the controller 20 determines that the refrigeration cycle is in the stable state, and ends the control switching processing. For example, the controller 20 may determine that the refrigeration cycle is in the stable state, after determining that the actual Td is within the predetermined Td range for a certain period of time.

Further, when the SC control is switched to the SHd control in step S14, the controller 20 determines whether or not the actual SHd is within the predetermined SHd range (for example, 20 to 30 degrees) (step S16). For example, the controller 20 determines whether or not the actual SHd is equal to or higher than a threshold E (for example, 20 degrees) and equal to or lower than a threshold F (for example, 30 degrees). When determining in step S16 that the actual SHd is not within the predetermined SHd range (NO), the controller 20 returns to step S12 and makes a determination again based on the operating characteristics.

On the other hand, when determining in step S16 that the actual SHd is within the predetermined SHd range (YES), the controller 20 determines that the refrigeration cycle is in the stable state, and ends the control switching processing. For example, the controller 20 may determine that the refrigeration cycle is in the stable state, after determining that the actual SHd is within the predetermined SHd range for a certain period of time.

Note that the controller 20 may repeatedly perform the processing of switching between the SC control and the Td control or the SHd control even after the refrigeration cycle is stabilized. As a result, the refrigeration cycle apparatus 100 can continuously ensure the reliability of the operation even when the operating characteristics (for example, air conditioning load, etc.) fluctuate.

As described above, the refrigeration cycle apparatus 100 according to the present embodiment controls the opening degree of the expansion valve 104 based on any of the SC control (supercooling degree control) and the Td control (discharge temperature control) or the SHd control (discharge superheating degree control), thereby realizing both the securing of the necessary capacity and the protection of the operation. Therefore, according to the present embodiment, it is possible to provide the highly reliable refrigeration cycle apparatus 100 that does not stop the operation due to an abnormality in discharge temperature even in an operating state where it is difficult to secure an SC (supercooling degree).

For example, the refrigeration cycle apparatus 100 may be applied to a low GWP (Global Warming Potential) refrigerant due to social trends such as environmental regulations. The characteristics of low GWP refrigerants are that they have an advantage of having a low environmental impact since they have a low GWP compared to conventional refrigerants, while they have a disadvantage of being flammable and slightly flammable. Due to the recent environmental regulations, saving in refrigerant of refrigeration cycle apparatuses is progressing. In addition, in the case of refrigerants that are flammable or slightly flammable, there is a safety issue if the refrigerant leaks inside a room. For these reasons, there is a tendency to reduce an amount of the refrigerant charged as much as possible. The refrigeration cycle apparatus 100 according to the present embodiment is particularly effective when using a refrigerant, such as a flammable refrigerant, for which the amount of refrigerant charged should be reduced.

### Second Embodiment

Next, a second embodiment will be described.

In the first embodiment, the example of switching between the SC control and the Td control or the SHd control according to the operating characteristics of the refrigeration cycle apparatus 100 has been described. In the present embodiment, an example in which a magnitude of an air conditioning load is used as a specific example of the operating characteristics will be described.

In a state where an amount of the refrigerant charged in the refrigerating cycle is reduced, the required air conditioning capacity is reduced when the air conditioning load is small. For this reason, an operating frequency of the compressor 101 is lowered. As a result, the amount of the refrigerant circulating in the refrigeration cycle apparatus 100 is reduced. For this reason, it is assumed that the actual measurement value does not satisfy the predetermined SC range required to perform the SC control. Therefore, when determining that the air conditioning load of the refrigeration cycle apparatus 100 is small, the controller 20 switches the SC control to the Td control or the SHd control.

As an example, the controller 20 can determine a magnitude of the air conditioning load based on an actual operating frequency of the compressor 101 controlled during the operation (hereinafter referred to as “actual operating frequency”). For example, when the actual operating frequency of the compressor 101 is lower than a predetermined threshold value (for example, 40 Hz), the controller 20 determines that the air conditioning load is small, and switches the SC control to the Td control or the SHd control. On the other hand, when the actual operating frequency of the compressor 101 is equal to or higher than the predetermined threshold value (for example, 40 Hz), the controller 20 determines that the air conditioning load is not small, and continues the SC control. This predetermined threshold is hereinafter referred to as “threshold operating frequency.”

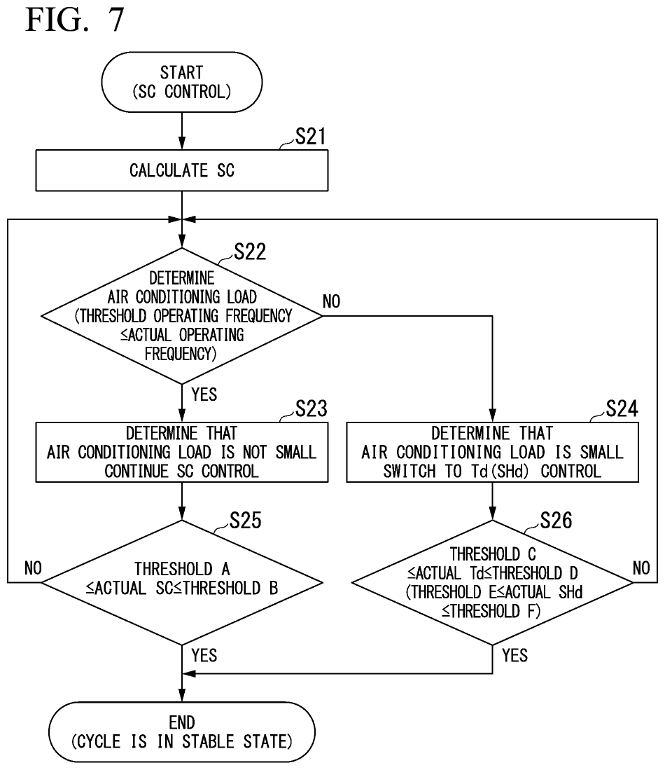

FIG. 7 is a flowchart showing an example of switching processing for the refrigeration cycle apparatus 100 according to the present embodiment to switch between the SC control and the Td control or the SHd control according to an operating frequency of the compressor 101. Processes of steps S21, S25, and S26 shown in FIG. 7 are the same as the respective processes of steps S11, S15, and S16 shown in FIG. 6, and the description thereof will be omitted. Here, the difference is that the control is switched according to the air conditioning load (as an example, an operating frequency of the compressor 101) in steps S22, S23, and S24, as an example of the processing of switching the control according to the operating characteristics in steps S12, S13, and S14 shown in FIG. 6.

The controller 20 determines a magnitude of the air conditioning load of the refrigeration cycle apparatus 100 (step S22). As the determination of the air conditioning load, for example, the controller 20 determines whether or not the actual operating frequency of the compressor 101 is equal to or higher than the threshold operating frequency (for example, 40 Hz). When determining in step S22 that the actual operating frequency is equal to or higher than the threshold operating frequency (YES), the controller 20 determines that the air conditioning load is not small, continues the SC control (step S23), and then proceeds to step S25.

On the other hand, when determining in step S22 that the actual operating frequency is lower than the threshold operating frequency (NO), the controller 20 determines that the air conditioning load is small, switches the SC control to the Td control or the SHd control (step S24), and then proceeds to step S26.

Note that even after the refrigeration cycle is stabilized, the controller 20 may repeatedly perform the processing in FIG. 7 of switching between the SC control and the Td control or the SHd control, in the same manner as described in the switching processing shown in FIG. 6. As a result, the refrigeration cycle apparatus 100 can continuously ensure the reliability of the operation even when the operating characteristics (for example, air conditioning load, etc.) fluctuate.

As described above, when the operating frequency of the compressor 101 is lower than the predetermined threshold, the refrigeration cycle apparatus 100 according to the present embodiment switches the control of the opening degree of the expansion valve 104 from the SC control (supercooling degree control) to the Td control (discharge temperature control) or the SHd control (discharge superheating degree control).

As a result, based on the threshold of the operating frequency of the compressor 101, the refrigeration cycle apparatus 100 can switch the control of the opening degree of the expansion valve 104 from the SC control to the Td control or the SHd control, in an operating state where it is difficult to secure an SC, for example, in an operating state where the air conditioning load is small and the operating frequency of the compressor 101 is lowered. Therefore, according to the present embodiment, it is possible to provide the highly reliable refrigeration cycle apparatus 100 that can prevent the operation from stopping by previously suppressing excessive narrowing of the expansion valve 104 and performing the operation to prevent an abnormality in discharge temperature or the like.

### Third Embodiment

Next, a third embodiment will be described.

In the first embodiment, the example of switching between the SC control and the Td control or the SHd control according to the operating characteristics of the refrigeration cycle apparatus 100 has been described. In the present embodiment, an example where a value of the SC is used as a specific example of the operating characteristics will be described.

In a state where the amount of the refrigerant charged in the refrigeration cycle is reduced, an operating state where the surplus refrigerant in the refrigeration cycle decreases is assumed, and it is conceivable that the actual SC does not satisfy the predetermined SC range required to perform the SC control. For this reason, the controller 20 switches the SC control to the Td control or the SHd control when the actual SC is lower than a predetermined threshold (hereinafter referred to as “threshold SC”).

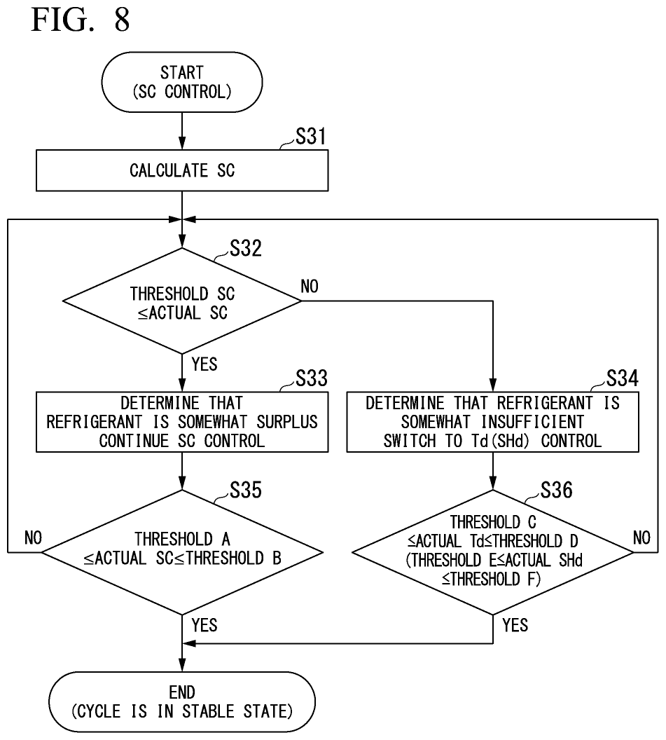

FIG. 8 is a flowchart showing an example of switching processing for the refrigeration cycle apparatus 100 according to the present embodiment to switch between the SC control and the Td control or the SHd control according to a value of the SC. The processes of steps S31, S35, and S36 shown in FIG. 8 are the same as the respective processes of steps S11, S15, and S16 shown in FIG. 6, and the description thereof will be omitted. Here, the difference is that the control is switched according to a value of the SC in steps S32, S33, and S34 as an example of the processing of switching the control according to the operating characteristics in steps S12, S13, and S14 shown in FIG. 6.

The controller 20 determines whether or not the actual SC calculated based on the detected condensation temperature and the detected condenser outlet temperature is equal to or higher than the threshold SC (for example, 2 degrees) (step S32). When determining in step S32 that the actual SC is equal to or higher than the threshold SC (YES), the controller 20 determines that the refrigerant is somewhat surplus, continues the SC control (step S33), and then proceeds to step S35.

On the other hand, when determining in step S32 that the actual SC is lower than the threshold value SC (NO), the controller 20 determines that the refrigerant is somewhat insufficient, switches the SC control to the Td control or the SHd control (step S34), and then proceeds to step S36.

Note that even after the refrigeration cycle is stabilized, the controller 20 may repeatedly perform the processing in FIG. 8 of switching between the SC control and the Td control or the SHd control, in the same manner as described in the switching processing shown in FIG. 6. As a result, the refrigeration cycle apparatus 100 can continuously ensure the reliability of the operation even when the operating characteristics (for example, air conditioning load, etc.) fluctuate.

As described above, when the SC (supercooling degree) of the condenser (for example, the heat source side heat exchanger 103) is lower than the predetermined threshold, the refrigeration cycle apparatus 100 according to the present embodiment switches the control of the opening degree of the expansion valve 104 from the SC control (supercooling degree control) to the Td control (discharge temperature control) or the SHd control (discharge superheating degree control).

As a result, based on the threshold of the SC of the condenser, the refrigeration cycle apparatus 100 can switch the control of the opening degree of the expansion valve 104 from the SC control to the Td control or the SHd control, even in a region where assumed is an operating state where it is difficult to secure an SC, for example, an operating state where a ratio of the refrigerant in the refrigerating cycle decreases due to differences in the installation environments and cooling/heating operation modes. Therefore, according to the present embodiment, it is possible to provide the highly reliable refrigeration cycle apparatus 100 that can prevent the operation from stopping by previously suppressing excessive narrowing of the expansion valve 104 and performing the operation to prevent an abnormality in discharge temperature or the like.

### Fourth Embodiment

Next, a fourth embodiment will be described.

In the first embodiment, the example of switching between the SC control and the Td control or the SHd control according to the operating characteristics of the refrigeration cycle apparatus 100 has been described. In the present embodiment, an example where an opening degree of the expansion valve 104 is used as a specific example of the operating characteristics in order for determination for the operational protection will be described.

In a state where the amount of the refrigerant charged in the refrigeration cycle is reduced, an operating state where the surplus refrigerant in the refrigeration cycle decreases is assumed, and it is conceivable that the actual SC does not satisfy the predetermined SC range required to perform the SC control. For this reason, the controller 20 switches the SC control to the Td control or the SHd control when the actual opening degree of the expansion valve 104 controlled during the operation (hereinafter referred to as “actual expansion valve opening degree”) is lower than a predetermined threshold value (hereinafter referred to as “threshold expansion valve opening degree”).

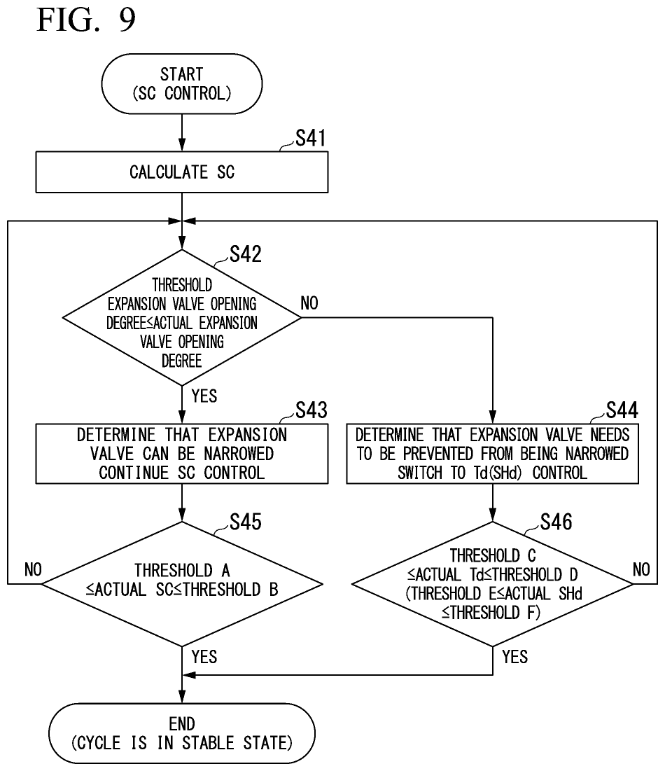

FIG. 9 is a flowchart showing an example of switching processing for the refrigeration cycle apparatus 100 according to the present embodiment to switch between the SC control and the Td control or the SHd control according to an opening degree of the expansion valve 104. The processes of steps S41, S45, and S46 shown in FIG. 9 are the same as the respective processes of steps S11, S15, and S16 shown in FIG. 6, and the description thereof will be omitted. Here, the difference is that the control is switched according to an opening degree of the expansion valve 104 in steps S42, S43, and S44 as an example of the processing of switching the control according to the operating characteristics in steps S12, S13, and S14 shown in FIG. 6.

The controller 20 determines whether or not the actual expansion valve opening degree is equal to or higher than the threshold expansion valve opening degree (for example, 20%) (step S42). When determining in step S42 that the actual expansion valve opening degree is equal to or higher than the threshold expansion valve opening degree (YES), the controller 20 determines that the expansion valve 104 can be narrowed, continues the SC control (step S43), and then proceeds to step S45.

On the other hand, when determining in step S42 that the actual expansion valve opening degree is lower than the threshold expansion valve opening degree (NO), the controller determines that the narrowing of the expansion valve 104 causes an increase in the Td or the SHd, so that operational protection is necessary to prevent the condensation pressure in the refrigerant circuit 10 from increasing excessively. Therefore, the controller 20 determines that the expansion valve 104 needs to be prevented from being narrowed, switches the SC control to the Td control or the SHd control (step S44), and then proceeds to step S46.

Note that even after the refrigeration cycle is stabilized, the controller 20 may repeatedly perform the processing in FIG. 9 of switching between the SC control and the Td control or the SHd control, in the same manner as described in the switching processing shown in FIG. 6. As a result, the refrigeration cycle apparatus 100 can continuously ensure the reliability of the operation even when the operating characteristics (for example, air conditioning load, etc.) fluctuate.

As described above, when the opening degree of the expansion valve 104 is lower than the predetermined threshold, the refrigeration cycle apparatus 100 according to the present embodiment switches the control of the opening degree of the expansion valve 104 from the SC control (supercooling degree control) to the Td control (discharge temperature control) or the SHd control (discharge superheating degree control).

As a result, based on the threshold of the opening degree of the expansion valve 104, the refrigeration cycle apparatus 100 can switch the control of the opening degree of the expansion valve 104 from the SC control to the Td control or the SHd control, even in a region where assumed is the operational protection in the operating state where it is difficult to secure an SC, for example, the excessive narrowing of the expansion valve 104 in the operating state where the SC does not satisfy the predetermined control range. Therefore, according to the present embodiment, it is possible to provide the highly reliable refrigeration cycle apparatus that can prevent the operation from stopping by previously suppressing excessive narrowing of the expansion valve 104 and performing the operation to prevent an abnormality in discharge temperature or the like.

### Fifth Embodiment

Next, a fifth embodiment will be described.

In the present embodiment, a description will be given with respect to an example of switching between the SC control and the Td control or the SHd control according to an air conditioning load (operating frequency of the compressor 101), a value of the SC, and an opening degree of the expansion valve 104, which have been described respectively in the above-described second, third, and fourth embodiments.

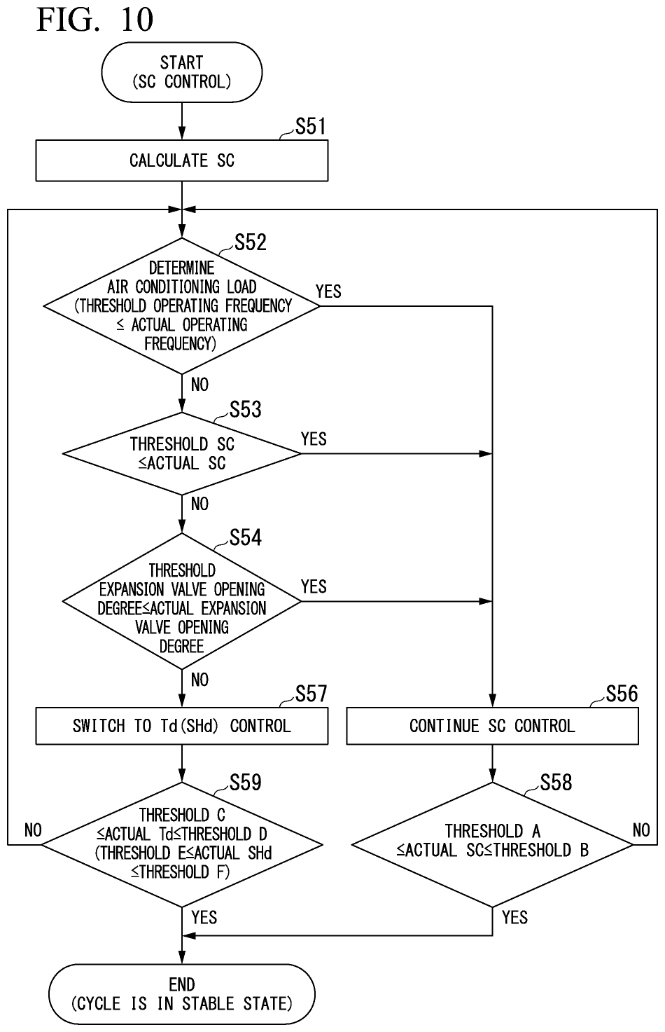

FIG. 10 is a flowchart showing an example of switching processing for the refrigeration cycle apparatus 100 according to the present embodiment to switch between the SC control and the Td control or the SHd control according to an air conditioning load (operating frequency of the compressor 101), a value of the SC, and an opening degree of the expansion valve 104. The processes of steps S51, S58, and S59 shown in FIG. 10 are the same as the respective processes of steps S11, S15, and S16 shown in FIG. 6, and the description thereof will be omitted. Here, the difference from the switching processing shown in FIG. 6 is that the control is switched based on results of respective determinations of an air conditioning load (for example, operating frequency of the compressor 101), a value of the SC, and an opening degree of the expansion valve 104.

The controller 20 determines a magnitude of the air conditioning load of the refrigeration cycle apparatus 100 (step S52). As the determination of the air conditioning load, for example, the controller 20 determines whether or not the actual operating frequency of the compressor 101 is equal to or higher than the threshold operating frequency (for example, 40 Hz). When determining in step S52 that the actual operating frequency is equal to or higher than the threshold operating frequency (YES), the controller 20 determines that the air conditioning load is not small, continues the SC control (step S56), and then proceeds to step S58.

On the other hand, when determining in step S52 that the actual operating frequency is lower than the threshold operating frequency (NO), the controller 20 determines that the air conditioning load is small, and proceeds to step S53.

The controller 20 determines whether or not the actual SC calculated based on the detected condensation temperature and the detected condenser outlet temperature is equal to or higher than the threshold SC (for example, 2 degrees) (step S53). When determining in step S53 that the actual SC is equal to or higher than the threshold SC (YES), the controller 20 determines that the refrigerant is somewhat surplus, continues the SC control (step S56), and then proceeds to step S58.

On the other hand, when determining in step S53 that the actual SC is lower than the threshold SC (NO), the controller 20 determines that the refrigerant is somewhat insufficient, and proceeds to step S54.

The controller 20 determines whether or not the actual expansion valve opening degree is equal to or higher than the threshold expansion valve opening degree (for example, 20%) (step S54). When determining in step S54 that the actual expansion valve opening degree is equal to or higher than the threshold expansion valve opening degree (YES), the controller 20 determines that the expansion valve 104 can be narrowed, continues the SC control (step S56), and then proceeds to step S58.

On the other hand, when determining in step S54 that the actual expansion valve opening degree is lower than the threshold expansion valve opening degree (NO), the controller determines that the air conditioning load is small, the refrigerant is somewhat insufficient, and the expansion valve 104 needs to be prevented from being narrowed, switches the SC control to Td control or SHd control (step S57), and then proceeds to step S59.

As described above, when the operating frequency of the compressor 101 is lower than the predetermined threshold, and the SC (supercooling degree) of the condenser (for example, the heat source side heat exchanger 103) is lower than the predetermined threshold, and the opening degree of the expansion valve 104 is lower than the predetermined threshold, the refrigeration cycle apparatus 100 according to the present embodiment switches the control of the opening degree of the expansion valve 104 from the SC control (supercooling degree control) to the Td control (discharge temperature control) or the SHd control (discharge superheating degree control).

As a result, the refrigeration cycle apparatus 100 can determine each of the operating frequency of the compressor 101, the SC of the condenser, and the opening degree of the expansion valve 104, and switch the control of the opening degree of the expansion valve 104 from the SC control to the Td control or the SHd control, even in a region where the operational protection is necessary to prevent the excessive narrowing of the expansion valve 104 in the operating state where it is difficult to secure an SC, for example, in the operating state where the air conditioning load is small and the operating frequency of the compressor 101 is lowered, or in the operating state where the SC does not satisfy the predetermined control range due to differences in the installation environments and cooling/heating operation modes. Therefore, according to the present embodiment, it is possible to provide the highly reliable refrigeration cycle apparatus that can prevent the operation from stopping by previously suppressing excessive narrowing of the expansion valve 104 and performing the operation to prevent an abnormality in discharge temperature or the like.

As described above, each embodiment has been described in detail with reference to the drawings, but the specific configuration is not limited to these embodiments, and each embodiment may be combined, modified, or omitted as appropriate.

In the above embodiments, the example using the SC of the heat source side heat exchanger 103 has been explained, but an SC of the user side heat exchanger 105 may be used. Alternatively, both the SC of the heat source side heat exchanger 103 and the SC of the user side heat exchanger 105 may be used.

Further, it has been described in the above-described first embodiment that even after the refrigeration cycle is stabilized, the controller 20 may repeatedly perform the processing in FIG. 6 of switching between the SC control and the Td control or the SHd control. Similarly, the processing shown in FIGS. 7, 8, 9, and 10 may also be repeatedly performed even after the refrigeration cycle is stabilized.

Note that a program for realizing the functions of the controller 20 may be recorded in a computer-readable recording medium, so that a computer system can read and execute the program recorded in the recording medium to perform the processing of the controller 20. Note that the “computer system” referred to here includes an OS and hardware such as peripheral devices.

Further, the “computer-readable recording medium” refers to portable media such as flexible disks, magneto-optical disks, ROMs and CD-ROMs, and storage devices such as hard disks built into computer systems. Further, the “computer-readable recording medium” includes: a medium that dynamically retains a program for a short period of time, such as a communication line in a case where the program is transmitted via a network such as the Internet or a communication line such as a telephone line; and a medium that retains a program for a certain period of time, such as a volatile memory inside a computer system that serves as a server or a client in the above case. Further, the above-described program may be one for realizing part of the functions described above, or may be one capable of realizing the functions described above in combination with a program already recorded in the computer system. Further, the above-described program may be stored in a predetermined server, so that it will be distributed (downloaded, or the like) via a communication line in response to a request from another device.

Further, part or all of the functions of the controller 20 may be implemented as an integrated circuit such as an LSI (Large Scale Integration). Each function may be individually processorized, and part or all of the functions may be integrated and processorized. Further, the integrated circuit is not limited to an LSI, and may be implemented as a dedicated circuit or a general-purpose processor. Further, when an integrated circuit technology that replaces the LSI appears due to advances in semiconductor technology, an integrated circuit based on that technology may be used.

1. A refrigeration cycle apparatus comprising a refrigerant circuit in which a compressor, a heat source side heat exchanger, an expansion valve, and a user side heat exchanger are connected by a refrigerant pipe, the refrigeration cycle apparatus comprising:
a detector configured to detect a discharge temperature of the compressor, and a heat transfer pipe temperature and an outlet pipe temperature of at least one heat exchanger of the heat source side heat exchanger and the user side heat exchanger, the at least one heat exchanger functioning as a condenser; and
a controller capable of performing a supercooling degree control and a discharge temperature control or a discharge superheating degree control, based on a result of the detection by the detector,
wherein the controller is configured to
when the refrigeration cycle apparatus starts operating, control an opening degree of the expansion valve based on the supercooling degree control, and
when determining based on operating characteristics of the refrigeration cycle apparatus that the supercooling degree control cannot be continued, switch the control of the opening degree of the expansion valve from the supercooling degree control to the discharge temperature control or the discharge superheating degree control.

2. The refrigeration cycle apparatus of claim 1, wherein
one of the operating characteristics is an operating frequency of the compressor, and
the controller is configured to, when the operating frequency of the compressor is lower than a predetermined threshold, switch the control of the opening degree of the expansion valve from the supercooling degree control to the discharge temperature control or the discharge superheating degree control.

3. The refrigeration cycle apparatus of claim 1, wherein
one of the operating characteristics is a supercooling degree of the at least one heat exchanger, and
the controller is configured to, when the supercooling degree of the at least one heat exchanger is lower than a predetermined threshold, switch the control of the opening degree of the expansion valve from the supercooling degree control to the discharge temperature control or the discharge superheating degree control.

4. The refrigeration cycle apparatus of claim 1, wherein
one of the operating characteristics is the opening degree of the expansion valve, and
the controller is configured to, when the opening degree of the expansion valve is lower than a predetermined threshold, switch the control of the opening degree of the expansion valve from the supercooling degree control to the discharge temperature control or the discharge superheating degree control.

5. The refrigeration cycle apparatus of claim 1, wherein
the operating characteristics include an operating frequency of the compressor, a supercooling degree of the at least one heat exchanger, and the opening degree of the expansion valve, and
the controller is configured to, when the operating frequency of the compressor is lower than a predetermined threshold, the supercooling degree of the at least one heat exchanger is lower than a predetermined threshold, and the opening degree of the expansion valve is lower than a predetermined threshold, switch the control of the opening degree of the expansion valve from the supercooling degree control to the discharge temperature control or the discharge superheating degree control.

6. A control method for a refrigeration cycle apparatus comprising a refrigerant circuit in which a compressor, a heat source side heat exchanger, an expansion valve, and a user side heat exchanger are connected by a refrigerant pipe, the control method comprising:
detecting a discharge temperature of the compressor, and a heat transfer pipe temperature and an outlet pipe temperature of at least one heat exchanger of the heat source side heat exchanger and the user side heat exchanger, the at least one heat exchanger functioning as a condenser;
performing a supercooling degree control and a discharge temperature control or a discharge superheating degree control, based on a result of the detection;
when the refrigeration cycle apparatus starts operating, controlling an opening degree of the expansion valve based on the supercooling degree control; and
when determining based on operating characteristics of the refrigeration cycle apparatus that the supercooling degree control cannot be continued, switching the control of the opening degree of the expansion valve from the supercooling degree control to the discharge temperature control or the discharge superheating degree control.

7. The control method of claim 6, wherein
one of the operating characteristics is an operating frequency of the compressor, and
the control method further comprises
when the operating frequency of the compressor is lower than a predetermined threshold, switching the control of the opening degree of the expansion valve from the supercooling degree control to the discharge temperature control or the discharge superheating degree control.

8. The control method of claim 6, wherein
one of the operating characteristics is a supercooling degree of the at least one heat exchanger, and
the control method further comprises
when the supercooling degree of the at least one heat exchanger is lower than a predetermined threshold, switching the control of the opening degree of the expansion valve from the supercooling degree control to the discharge temperature control or the discharge superheating degree control.

9. The control method of claim 6, wherein
one of the operating characteristics is the opening degree of the expansion valve, and
the control method further comprises
when the opening degree of the expansion valve is lower than a predetermined threshold, switching the control of the opening degree of the expansion valve from the supercooling degree control to the discharge temperature control or the discharge superheating degree control.

10. The control method of claim 6, wherein
the operating characteristics include an operating frequency of the compressor, a supercooling degree of the at least one heat exchanger, and the opening degree of the expansion valve, and
the control method further comprises
when the operating frequency of the compressor is lower than a predetermined threshold, the supercooling degree of the at least one heat exchanger is lower than a predetermined threshold, and the opening degree of the expansion valve is lower than a predetermined threshold, switching the control of the opening degree of the expansion valve from the supercooling degree control to the discharge temperature control or the discharge superheating degree control.

11. A non-transitory computer-readable recording medium storing instructions causing a computer of a refrigeration cycle apparatus comprising a refrigerant circuit in which a compressor, a heat source side heat exchanger, an expansion valve, and a user side heat exchanger are connected by a refrigerant pipe to:
detect a discharge temperature of the compressor, and a heat transfer pipe temperature and an outlet pipe temperature of at least one heat exchanger of the heat source side heat exchanger and the user side heat exchanger, the at least one heat exchanger functioning as a condenser;
perform a supercooling degree control and a discharge temperature control or a discharge superheating degree control, based on a result of the detection;
when the refrigeration cycle apparatus starts operating, control an opening degree of the expansion valve based on the supercooling degree control; and
when determining based on operating characteristics of the refrigeration cycle apparatus that the supercooling degree control cannot be continued, switch the control of the opening degree of the expansion valve from the supercooling degree control to the discharge temperature control or the discharge superheating degree control.

12. The non-transitory computer-readable recording medium of claim 11, wherein
one of the operating characteristics is an operating frequency of the compressor, and
the instructions further causes the computer to
when the operating frequency of the compressor is lower than a predetermined threshold, switch the control of the opening degree of the expansion valve from the supercooling degree control to the discharge temperature control or the discharge superheating degree control.

13. The non-transitory computer-readable recording medium of claim 11, wherein
one of the operating characteristics is a supercooling degree of the at least one heat exchanger, and
the instructions further causes the computer to
when the supercooling degree of the at least one heat exchanger is lower than a predetermined threshold, switch the control of the opening degree of the expansion valve from the supercooling degree control to the discharge temperature control or the discharge superheating degree control.

14. The non-transitory computer-readable recording medium of claim 11, wherein
one of the operating characteristics is the opening degree of the expansion valve, and
the instructions further causes the computer to
when the opening degree of the expansion valve is lower than a predetermined threshold, switch the control of the opening degree of the expansion valve from the supercooling degree control to the discharge temperature control or the discharge superheating degree control.

15. The non-transitory computer-readable recording medium of claim 11, wherein
the operating characteristics include an operating frequency of the compressor, a supercooling degree of the at least one heat exchanger, and the opening degree of the expansion valve, and
the instructions further causes the computer to
when the operating frequency of the compressor is lower than a predetermined threshold, the supercooling degree of the at least one heat exchanger is lower than a predetermined threshold, and the opening degree of the expansion valve is lower than a predetermined threshold, switch the control of the opening degree of the expansion valve from the supercooling degree control to the discharge temperature control or the discharge superheating degree control.
